(19) United States
(12) Patent Application Publication
(10) Pub. No.: US 2021/0391802 A1
(43) Pub. Date: Dec. 16, 2021

(54) DC-DC CONVERTER

(71) Applicant: Mitsubishi Electric Corporation, Chiyoda-ku, Tokyo (JP)

(72) Inventors: Shohei HIGASHITANI, Tokyo (JP); Norihiro SUZUKI, Tokyo (JP); Masanori KAGEYAMA, Tokyo (JP)

(73) Assignee: Mitsubishi Electric Corporation, Chiyoda-ku, Tokyo (JP)

(21) Appl. No.: 17/288,581

(22) PCT Filed: Dec. 11, 2019
(86) PCT No.: PCT/JP2019/048437

§ 371 Date: Apr. 26, 2021

(30) Foreign Application Priority Data
Dec. 18, 2018 (JP) 2018-236026

(51) Int. Cl. H02M 3/335

(52) U.S. Cl. CPC H02M 3/33592; H02M 3/33561

(57) ABSTRACT

It is an object to provide a technique capable of achieving a multi-output DC-DC converter mounted at low cost or high density. A DC-DC converter includes a transformer, a first circuit, and at least one second circuit. The second circuit includes an individual control device selectively accumulating and taking out an electrical power in a secondary winding corresponding to the second circuit based on an electrical power taken out from the secondary winding, and converts an AC voltage of the secondary winding into a DC voltage.

### TECHNICAL FIELD

The present invention relates to a DC-DC converter, and particularly to a DC-DC converter applicable to a multi-output DC-DC converter capable of outputting plural different output voltage.

### BACKGROUND ART

The DC-DC converter has a function of increasing and decreasing a DC voltage to output it. Such a DC-DC converter includes a multi-output DC-DC converter having a plurality of output circuits to output plural different output voltage. In the multi-output DC-DC converter performing multi-output in a DC-DC converter using a transformer, a plurality of output circuits are made up of a plurality of secondary side windings and a plurality of secondary side rectifying circuit of the transformer.

A conventional multi-output DC-DC converter detects output voltage of one output circuit in a plurality of output circuits, and controls a conduction ratio of a primary side switching element of the transformer so that the output voltage becomes a target value, thereby controlling output voltage of one output circuit described above. In the meanwhile, output voltage of the other output circuit, that is to say, the output voltage which is not directly controlled is roughly calculated using a turn ratio of the transformer to the output voltage which is directly controlled. A technique of a multi-output DC-DC converter is also proposed in Patent Document 1.

### PRIOR ART DOCUMENTS

### Patent Documents

Patent Document 1: Japanese Patent Application Laid-Open No. 2015-154506

### SUMMARY

### Problem to be Solved by the Invention

The output voltage which is not directly controlled in the multi-output DC-DC converter fluctuates depending on a load and input voltage in each output circuit, thus can be hardly adjusted accurately. In the meanwhile, in the technique of Patent Document 1, each output circuit can be adjusted in some degree.

However, in the technique of Patent Document 1, energy accumulated in a secondary side inductor provided individually from the transformer is taken out only as needed using a secondary side switching element. In such a configuration, a magnetic component, whose number corresponds to the number of outputs, such as an inductor having a relatively large area, needs to be mounted to a converter. Thus, the multi-output DC-DC converter mounted at low cost or high density can be hardly achieved.

The present invention therefore has been made to solve the above problems, and it is an object of the present invention to provide a technique capable of achieving a multi-output DC-DC converter mounted at low cost or high density.

### Means to Solve the Problem

A DC-DC converter according to the present invention includes: a transformer including a primary winding, at least one secondary winding, and a tertiary winding; a first circuit connected to the primary winding and the tertiary winding; and at least one second circuit connected to the at least one secondary winding, wherein the first circuit includes: a first switching element converting a predetermined DC voltage into an AC voltage, and supplies the AC voltage to the primary winding; and a main control device controlling a conduction ratio of the first switching element based on an electrical power of the tertiary winding, the second circuit includes an individual control device selectively accumulating and taking out an electrical power in the secondary winding corresponding to the second circuit based on the electrical power taken out from the secondary winding, and the second circuit converts an AC voltage of the secondary winding corresponding to the second circuit into a DC voltage.

### Effects of the Invention

According to the present invention, the individual control device of the second circuit selectively accumulates and takes out an electrical power in the secondary winding corresponding to the second circuit based on the electrical power taken out from the secondary winding. According to such a configuration, the multi-output DC-DC converter mounted at low cost or high density can be achieved.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 A circuit diagram illustrating a configuration of a DC-DC converter according to an embodiment 1.

FIG. 2 A block diagram illustrating an example of a configuration of an individual control device according to the embodiment 1.

FIG. 3 A circuit diagram illustrating an example of a configuration of the individual control device according to the embodiment 1.

FIG. 4 A circuit diagram illustrating a configuration of a first related DC-DC converter.

FIG. 5 A circuit diagram illustrating a configuration of a DC-DC converter according to an embodiment 2.

FIG. 6 A circuit diagram illustrating a configuration of a second related DC-DC converter.

FIG. 7 A circuit diagram illustrating a configuration of a third related DC-DC converter.

FIG. 8 A circuit diagram illustrating a configuration of a DC-DC converter according to a modification example 1.

FIG. 9 A circuit diagram illustrating a configuration of a DC-DC converter according to a modification example 2.

FIG. 10 A block diagram illustrating an example of a configuration of an individual control device according to the modification example 2.

FIG. 11 A circuit diagram illustrating a configuration of a DC-DC converter according to an embodiment 3.

FIG. 12 A block diagram illustrating an example of a configuration of an individual control device according to the embodiment 3.

FIG. 13 A block diagram illustrating an example of a configuration of the individual control device according to the embodiment 3.

### DESCRIPTION OF EMBODIMENT(S)

### Embodiment 1

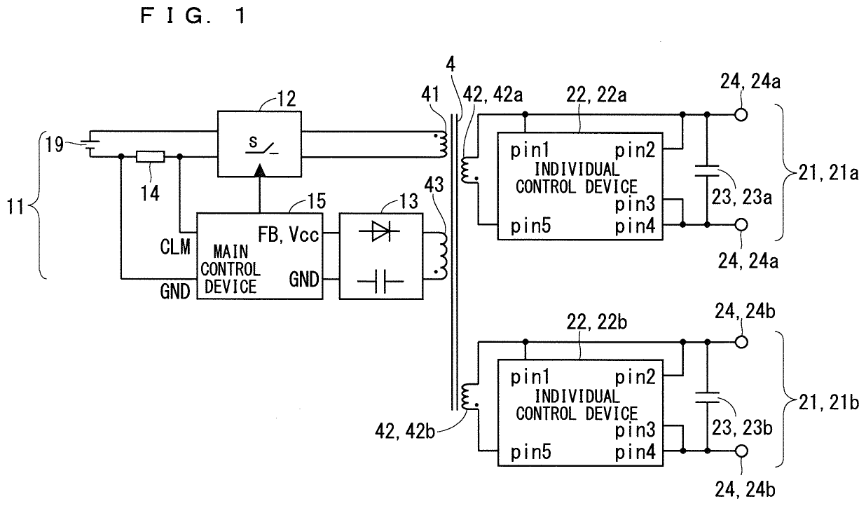

FIG. 1 is a circuit diagram illustrating a configuration of a DC-DC converter according to an embodiment 1 of the present invention. The DC-DC converter in FIG. 1 includes a transformer 4, a first circuit 11, and at least one second circuit 21. In the description hereinafter, at least one second circuit 21 according to the present embodiment 1 is second circuits 21a and 21b each functioning as an output circuit, and a DC-DC converter is a multi-output DC-DC converter having the second circuits 21a and 21b capable of outputting plural different output voltage.

The transformer 4 includes a primary winding 41, at least one secondary winding 42 having a secondary side excitation inductance, and a bias winding 43 which is a tertiary winding. In the present embodiment 1, at least one secondary winding 42 is secondary windings 42a and 42b, however, the number of secondary windings 42 is not limited thereto.

The first circuit 11 is connected to a DC power source 19, the primary winding 41, and the bias winding 43. The first circuit 11 in FIG. 1 includes a switching element 12 which is a first switching element, a rectifying circuit 13, a current detection resistance 14, and a main control device 15.

The switching element 12 converts a predetermined DC voltage being input from the DC power source 19 into an AC voltage under control of main control device 15, and supplies the AC voltage (electrical power) to the primary winding 41. A semiconductor switching element, for example, is applied to the switching element 12.

The rectifying circuit 13 converts the AC voltage of the electrical power taken out from the bias winding 43 into the DC voltage, and supplies the DC voltage to terminals Vcc, FB, and GND of main control device 15. Voltage between both ends of the current detection resistance 14 increases when the current in the primary winding 41 increases. This voltage between both ends is detected by main control device 15 via terminals CLM and GND.

The main control device 15 controls a conduction ratio of the switching element 12, that is to say, a ratio of conduction time of a pulse drive signal based on the electrical power of the bias winding 43. The electrical power of the bias winding 43 herein indicates voltage being input via the rectifying circuit 13, for example.

The second circuit 21 is described next. Each second circuit 21 is connected to the secondary winding 42, and includes an individual control device 22 individually controlling the second circuit 21, a capacitor 23, and a pair of output terminals 24. In the example in FIG. 1, the second circuit 21a is connected to the secondary winding 42a, and includes an individual control device 22a individually controlling the second circuit 21a, a capacitor 23a, and a pair of output terminals 24a. Similarly, the second circuit 21b is connected to the secondary winding 42b, and includes an individual control device 22b individually controlling the second circuit 21b, a capacitor 23b, and a pair of output terminals 24b.

The individual control device 22a takes out the electrical power (energy) from the secondary winding 42a corresponding to the second circuit 21a. Then, the individual control device 22a selectively accumulates and takes out (consumes) the electrical power in the secondary winding 42a based on the electrical power which has been taken out. The individual control device 22a performs feedback in this manner, thus the voltage being output from the output terminal 24a is brought close to a target value which is preset in the second circuit 21a.

Similarly, the individual control device 22b takes out the electrical power from the secondary winding 42b corresponding to the second circuit 21b, and selectively accumulates and takes out the electrical power in the secondary winding 42b based on the electrical power which has been taken out.

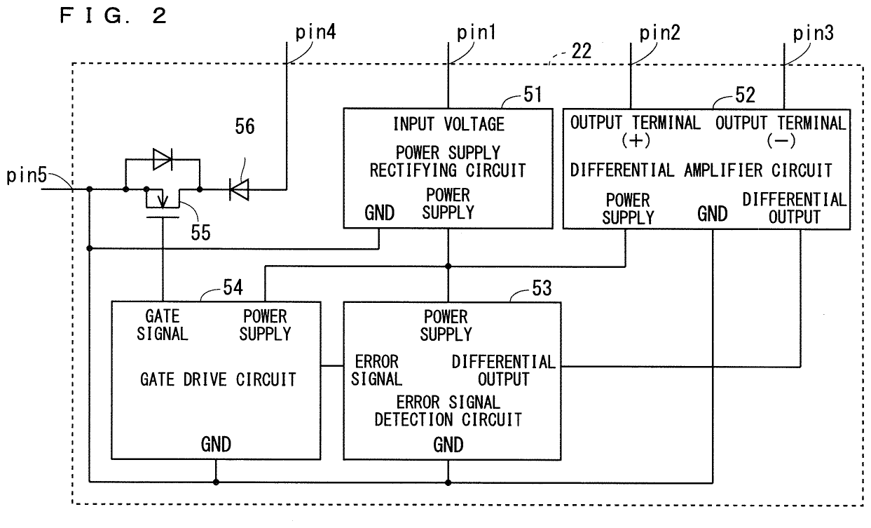

FIG. 2 is a block diagram illustrating an example of a configuration of the individual control device 22 (the individual control device 22a, 22b) according to the present embodiment 1. The individual control device 22 includes a power supply rectifying circuit 51, a differential amplifier circuit 52, an error signal detection circuit 53, a gate drive circuit 54, a switching element 55 which is a second switching element, and a diode 56.

Terminals pin 1 to pin 5 in FIG. 2 correspond to terminals pin 1 to pin 5 in FIG. 1, respectively. As illustrated in FIG. 1, one output terminal 24, the terminal pin 1, and the terminal pin 2 are connected by one of a pair of wirings, and the other output terminal 24, the terminal pin 3, and the terminal pin 4 are connected by the other one of the pair of wirings. Potential of the terminal pin 5 is referential potential, and as illustrated in FIG. 2, the terminal pin 5 is connected to the power supply rectifying circuit 51, the differential amplifier circuit 52, the error signal detection circuit 53, and the gate drive circuit 54.

The power supply rectifying circuit 51 converts the electrical power being input from the secondary winding 42 to the terminal pin 1 into an electrical power necessary for operations of the differential amplifier circuit 52, the error signal detection circuit 53, and the gate drive circuit 54, and supplies the converted electrical power thereto. Voltage (differential output) of a pair of wirings between the individual control device 22 and the capacitor 23 in FIG. 1 is input to the differential amplifier circuit 52 via the terminals pin 2 and pin 3. The differential amplifier circuit 52 amplifies a difference of voltage between the pair of wirings. The voltage of the pair of wirings herein corresponds to the electrical power taken out from the secondary winding 42 by the individual control device 22.

The error signal detection circuit 53 generates an error signal based on a comparison between the voltage amplified in the differential amplifier circuit 52 and predetermined voltage (bandgap reference). The gate drive circuit 54 outputs a signal for reducing the difference between the amplified voltage and the bandgap reference to a gate terminal of the switching element 55 based on the error signal generated in the error signal detection circuit 53. The signal is input to the gate terminal of the switching element 55, thus an on state an off state of the switching element 55, that is to say, a conduction ratio of the switching element 55 is controlled.

A source terminal which is one end of the switching element 55 is connected to one end of the secondary winding in FIG. 1 via the terminal pin 5. A drain terminal which is the other end of the switching element 55 is connected to a cathode of the diode 56, and an anode of the diode 56 is connected to the terminal pin 4. In the example in FIG. 2, the switching element 55 is an N-type metal oxide semiconductor field effect transistor (MOSFET) to which a reflux diode is added. The switching element 55 is not limited thereto, however, a semiconductor switching element such as a P-type MOSFET and an insulated gate bipolar transistor (IGBT) is also applicable.

The individual control device 22 having the above configuration selectively performs switching of the switching element 55 from the on state to the off state and switching of the element 55 from the off state to the on state based on the electrical power taken out from the secondary winding 42 when current flows in a forward direction of the diode 56. The individual control device 22 controls such a switching, that is to say, the conduction ratio of the switching element 55, thereby selectively accumulating and taking out the electrical power in the secondary winding 42.

The second circuit 21 in FIG. 1 converts the AC voltage of the secondary winding 42 corresponding to the second circuit 21 into the DC voltage by controlling the conduction ratio of the switching element 55 in the individual control device 22 and by the capacitor 23, for example, and outputs the DC voltage from the pair of output terminals 24. According to the above configuration, the individual control device 22 performs the feedback to the electrical power taken out from the secondary winding 42, thus the second circuit 21 can output the DC voltage brought close to the target value of the second circuit 21 from the pair of output terminals 24.

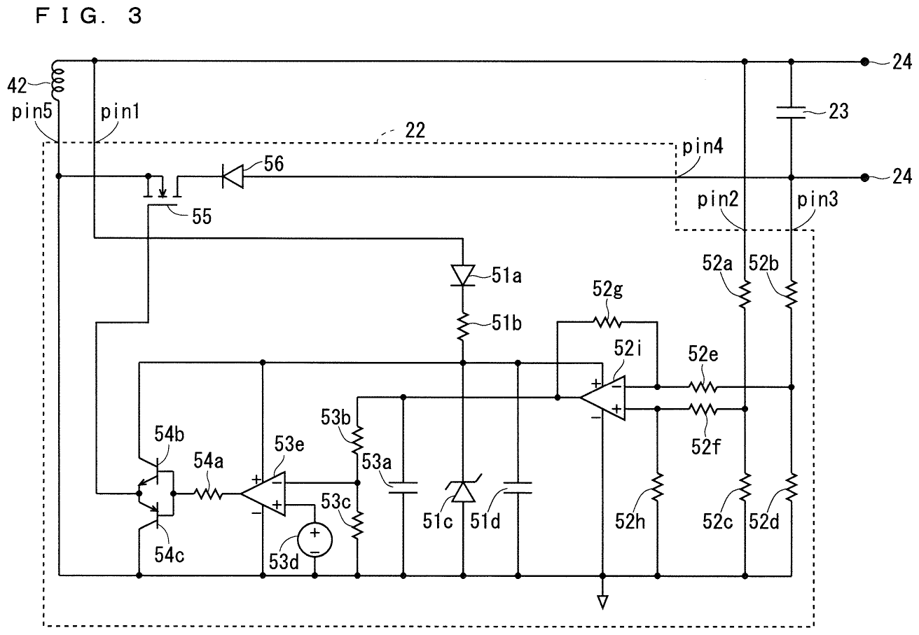

FIG. 3 is a circuit diagram illustrating an example of a configuration of the individual control device 22 (the individual control device 22a, 22b) according to the present embodiment 1. The power supply rectifying circuit 51 in FIG. 2 includes a diode 51a, a resistance 51b, a constant voltage diode 51c, and a capacitor 51d in FIG. 3. The differential amplifier circuit 52 in FIG. 2 includes resistances 52a, 52b, 52c, 52d, 52e, 52f, 52g and 52h and an operational amplifier 52i in FIG. 3.

The error signal detection circuit 53 in FIG. 2 includes a capacitor 53a, resistances 53b and 53c, a power source 53d, and an operational amplifier 53e in FIG. 3. The gate drive circuit 54 includes a resistance 54a and switching elements 54b and 54c in FIG. 3.

The configuration of the individual control device 22 is not limited to that described above. For example, in the individual control device 22, the switching element 55 and the diode 56 may be replaced with the other circuit having a function similar thereto. It is also applicable that the number of pins of the individual control device 22 is increased to externally mount a circuit element constituting the individual control device 22 and the number of circuit elements in the individual control device 22 is thereby reduced. In FIG. 1, the switching element 55 is connected to a winding start side (a side marked with a point in FIG. 1) of the secondary winding 42, but may be connected to a winding end side thereof. In this case, a P-type MOSFET, for example, may be used as the switching element.

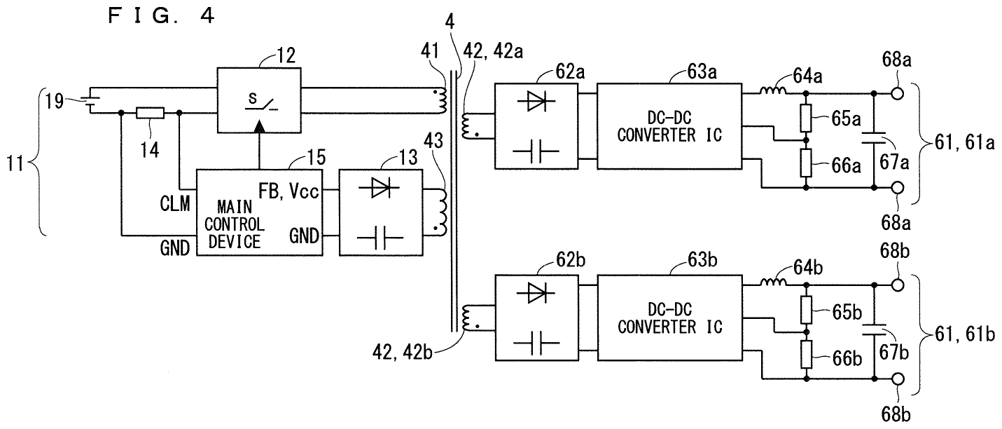

FIG. 4 is a circuit diagram illustrating a configuration of a DC-DC converter (referred to as “the first related DC-DC converter” hereinafter) relating to the DC-DC converter according to the present embodiment 1. The same reference numerals as constituent elements of the DC-DC converter according to the present embodiment 1 will be assigned to the same or similar constituent elements of the first related DC-DC converter, and the different constituent elements are mainly described hereinafter. A fourth circuit 61 is described herein, and a third circuit is described hereinafter.

The first related DC-DC converter includes at least one fourth circuit 61 in place of at least one second circuit 21. At least one fourth circuit 61 in FIG. 4 is fourth circuits 61a and 61b each functioning as an output circuit.

The fourth circuit 61a is connected to the secondary winding 42a, and includes a rectifying circuit 62a, a DC-DC converter integrated circuit (IC) 63a, a secondary side inductor 64a, pressure dividing resistances 65a and 66a, a capacitor 67a, and a pair of output terminals 68a. Similarly, the fourth circuit 61b is connected to the secondary winding 42b, and includes a rectifying circuit 62b, a DC-DC converter IC 63b, a secondary side inductor 64b, pressure dividing resistances 65b and 66b, a capacitor 67b, and a pair of output terminals 68b. Constituent elements of the fourth circuit 61a are described hereinafter, and constituent elements of the fourth circuit 61b are similar to those in the description hereinafter.

The secondary side inductor 64a is provided individually from the secondary winding 42a corresponding to the fourth circuit 61a. The voltage of the secondary winding 42a is output to the secondary side inductor 64a via the DC-DC converter IC 63a, and the secondary side inductor 64a accumulates the electrical power taken out from the secondary winding 42a. The DC-DC converter IC 63a selectively accumulates and takes out (consumes) the electrical power in the secondary side inductor 64a based on the electrical power taken out from the secondary side inductor 64a. That is to say, the DC-DC converter IC63a controls a conduction ratio of a switching element provided inside the DC-DC converter IC 63a but not shown in the drawings based on the electrical power taken out from the secondary side inductor 64a.

The fourth circuit 61a converts the AC voltage of the secondary side inductor 64a into the DC voltage by controlling the conduction ratio of the switching element in the DC-DC converter IC 63a and by the capacitor 67a, for example, and outputs the DC voltage from the pair of output terminals 24. According to the above configuration, the DC-DC converter IC 63a performs the feedback on the electrical power taken out from the secondary side inductor 64a, thus the fourth circuit 61a can output the DC voltage brought close to the target value of the fourth circuit 61a from the pair of output terminals 68a.

The DC-DC converter IC and the secondary side inductor described above are generally necessary for each output circuit to bring each output voltage of the plurality of fourth circuits 61 which are the plurality of output circuits close to each target value different from each other in the first related DC-DC converter in FIG. 4. Thus, in the first related DC-DC converter, the number of components increases for them. Particularly, a large-size magnetic component is used for the secondary side inductor so as to accumulate and consume the energy, thus a configuration that they need to be mounted in accordance with the number of outputs causes a design limitation. As a result, a multi-output DC-DC converter mounted at low cost and high density is hardly achieved, and when there are a large number of outputs (for example, the number of outputs is equal to or larger than 10), the above problem is particularly actualized.

In the meanwhile, in the DC-DC converter in FIG. 1 according to the present embodiment 1, energy accumulated in the secondary winding 42 having a secondary side excitation inductance is taken out only as needed by the individual control device 22. According to such a configuration, highly accurate output voltage having fine regulation characteristics can be obtained in each output circuit of the multi output DC-DC converter. A magnetic component can be gathered in one transformer 4, thus a multi-output DC-DC converter mounted at low cost and high density can be achieved.

As described above, in the present embodiment 1, the individual control device 22 controls a timing of switching the switching element 55 from the on state to the off state or from the off state to the on state based on a comparison between the differential output and a bandgap reference when current flows in the diode 56 so that the output voltage of the output terminal 24b is brought close to the preset target value.

Herein, if the energy accumulated in the secondary winding 42 is too much in relation to output load, the output voltage of the second circuit 21 increases, thus there may be a case where the output voltage of the second circuit 21 is hardly brought close to the target value only by controlling the individual control device 22. Thus, when the main control device 15 detects increase in voltage of the bias winding 43 in accordance with the increase in the output voltage, the main control device 15 reduces the conduction ratio of the switching element 12 and reduces electrical power supplied to the primary winding 41. When the main control device 15 detects increase in voltage between both ends of the current detection resistance 14 in accordance with the increase in the output voltage, the main control device 15 reduces the conduction ratio of the switching element 12 and reduces electrical power supplied to the primary winding 41. In the manner described above, the excess energy accumulated in the secondary winding 42 can be reduced.

In the meanwhile, if the energy accumulated in the secondary winding 42 is too little in relation to output load, the output voltage of the second circuit 21 decreases, thus there may be a case where the output voltage of the second circuit 21 is hardly brought close to the target value only by controlling the individual control device 22. Thus, when the main control device 15 detects decrease in voltage of the bias winding 43 in accordance with the decrease in the output voltage or decrease in voltage between both ends of the current detection resistance 14, the main control device 15 increases the conduction ratio of the switching element 12 and increases an electrical power supplied to the primary winding 41. Accordingly, shortfall of the energy accumulated in the secondary winding 42 can be compensated.

### Embodiment 2

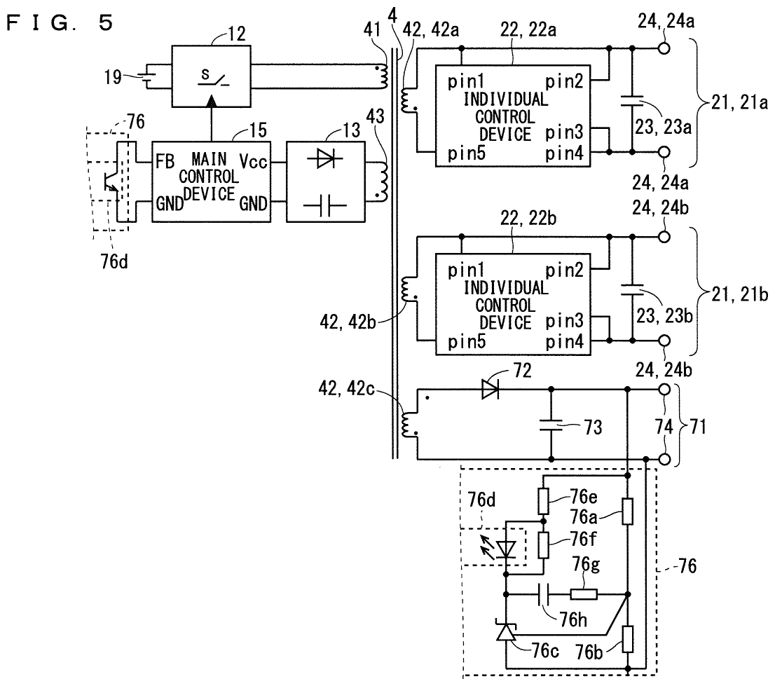

FIG. 5 is a circuit diagram illustrating a configuration of a DC-DC converter according to an embodiment 2 of the present invention. The same reference numerals as those described in the above embodiments will be assigned to the same or similar constituent element in the configuration according to the embodiment 2, and the different constituent elements are mainly described hereinafter.

A configuration of the DC-DC converter in FIG. 5 is similar to the configuration where a third circuit 71 which is an output circuit and a feedback circuit 76 are added in the configuration of the DC-DC converter in FIG. 1 and the current detection resistance 14 of the first circuit 11 is deleted from the configuration of the DC-DC converter in FIG. 1.

As described hereinafter, the DC-DC converter including the feedback circuit 76 according to the present embodiment 2 can have a higher accuracy of the output voltage than the DC-DC converter which does not include the feedback circuit 76 according to the embodiment 1.

The third circuit 71 is connected to a secondary winding 42c, and includes a diode 72, a capacitor 73, and a pair of output terminals 74. The third circuit 71 converts an AC voltage of the secondary winding 42c corresponding to the third circuit 71 into a DC voltage using the diode 72 and the capacitor 73, for example, and outputs the DC voltage from the pair of output terminals 74.

The feedback circuit 76 is a circuit stabilizing an output from the pair of output terminals 74 of the third circuit 71. The feedback circuit 76 is provided between the third circuit 71 and the first circuit 11, and is connected to the third circuit 71 and the first circuit 11.

The feedback circuit 76 in FIG. 5 includes pressure dividing resistances 76a and 76b, a shunt regulator 76c, a photo coupler 76d, resistances 76e, 76f, and 76g, and a capacitor 76h.

The pressure dividing resistances 76a and 76b divide the output voltage of the pair of output terminals 74. The shunt regulator 76c functions as a comparator comparing a detection signal, that is to say, a partial pressure of the output voltage obtained in a connection point between the voltage dividing resistances 76a and 76b with an internal reference power source, and amplifying a comparison result thereof.

The photo coupler 76d transmits a feedback signal based on the comparison result in the shunt regulator 76c to the primary side first circuit 11 of the transformer 4 with the feedback signal electrically isolated from the first circuit 11. That is to say, the photo coupler 76d transmits the feedback signal which is a signal corresponding to a fluctuation of the output voltage corresponding to the third circuit 71 to the first circuit 11. The main control device 15 of the first circuit 11 controls the conduction ratio of the switching element 12 based on the feedback signal isolated and transmitted by the photo coupler 76d and the voltage of the bias winding 43. The resistances 76e, 76f, and 76g, and the capacitor 76h are elements for adjusting a control parameter.

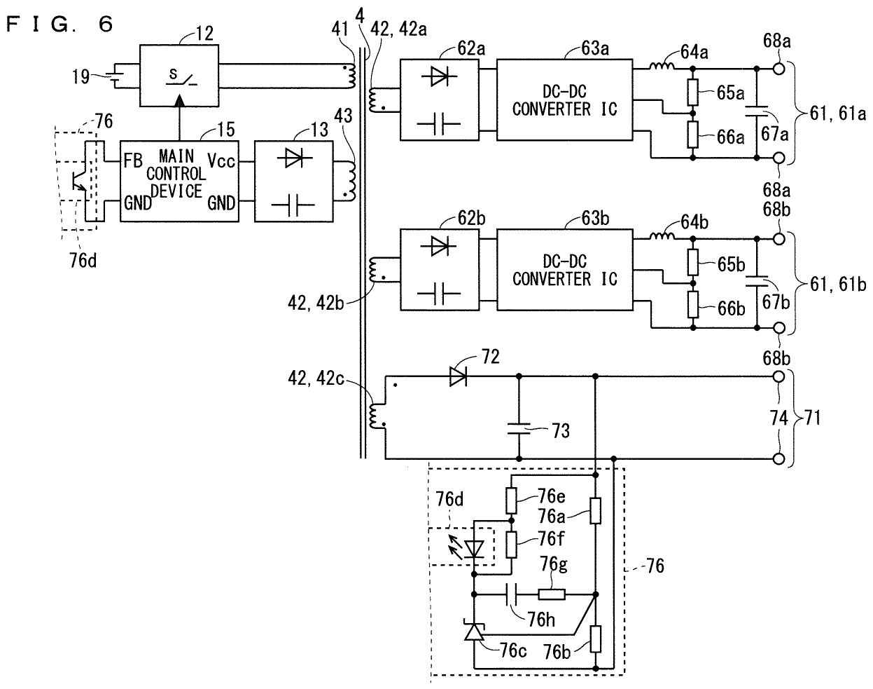

FIG. 6 is a circuit diagram illustrating a configuration of a DC-DC converter (referred to as “the second related DC-DC converter” hereinafter) relating to the DC-DC converter according to the present embodiment 2. The same reference numerals as those described in the constituent elements described above will be assigned to the same or similar constituent elements of the second related DC-DC converter, and the different constituent elements are mainly described hereinafter.

A configuration of the second related DC-DC converter in FIG. 6 is similar to the configuration where the feedback circuit 76 in FIG. 5 is added to the first related DC-DC converter in FIG. 4 and the current detection resistance 14 of the first circuit 11 is deleted from the configuration of the first related DC-DC converter in FIG. 4. Also in this second related DC-DC converter, the DC-DC converter IC and the secondary side inductor are necessary for each output circuit as with the first related DC-DC converter. Thus, a multi-output DC-DC converter mounted at low cost and high density is hardly achieved, and when there are a large number of outputs (for example, the number of outputs is equal to or larger than 10), the above problem is particularly actualized.

In the meanwhile, in the DC-DC converter in FIG. 5 according to the present embodiment 2, with regard to the second circuit 21, energy accumulated in the secondary winding 42 having a secondary side excitation inductance is taken out only as needed by the individual control device 22. According to such a configuration, highly accurate output voltage having fine regulation characteristics can be obtained in each output circuit of the multi output DC-DC converter. A magnetic component can be gathered in one transformer 4, thus a multi-output DC-DC converter mounted at low cost and high density can be achieved.

As described above, in the present embodiment 2, the individual control device 22 controls a timing of switching the switching element 55 from the on state to the off state or from the off state to the on state based on a comparison between the differential output and a bandgap reference when current flows in the diode 56 so that the output voltage of the output terminal 24b is brought close to the preset target value.

Herein, if the energy accumulated in the secondary winding 42 is too much in relation to output load, the output voltage of the second circuit 21 increases, thus there may be a case where the output voltage of the second circuit 21 is hardly brought close to the target value only by controlling the individual control device 22. Thus, when the main control device 15 detects increase in voltage of the bias winding 43 in accordance with the increase in the output voltage, the main control device 15 reduces the conduction ratio of the switching element 12 and reduces electrical power supplied to the primary winding 41. When the main control device 15 detects the feedback signal indicating increase in the output voltage of the third circuit 71, the main control device 15 reduces the conduction ratio of the switching element 12 and reduces electrical power supplied to the primary winding 41. In the manner described above, the excess energy accumulated in the secondary winding 42 can be reduced.

In the meanwhile, if the energy accumulated in the secondary winding 42 is too little in relation to output load, the output voltage of the second circuit 21 decreases, thus there may be a case where the output voltage of the second circuit 21 is hardly brought close to the target value only by controlling the individual control device 22. Thus, when the main control device 15 detects decrease in voltage of the bias winding 43 in accordance with the decrease in the output voltage or the feedback signal indicating decrease in the output voltage of the third circuit 71, the main control device 15 increases the conduction ratio of the switching element 12 and increases an electrical power supplied to the primary winding 41. Accordingly, shortfall of the energy accumulated in the secondary winding 42 can be compensated.

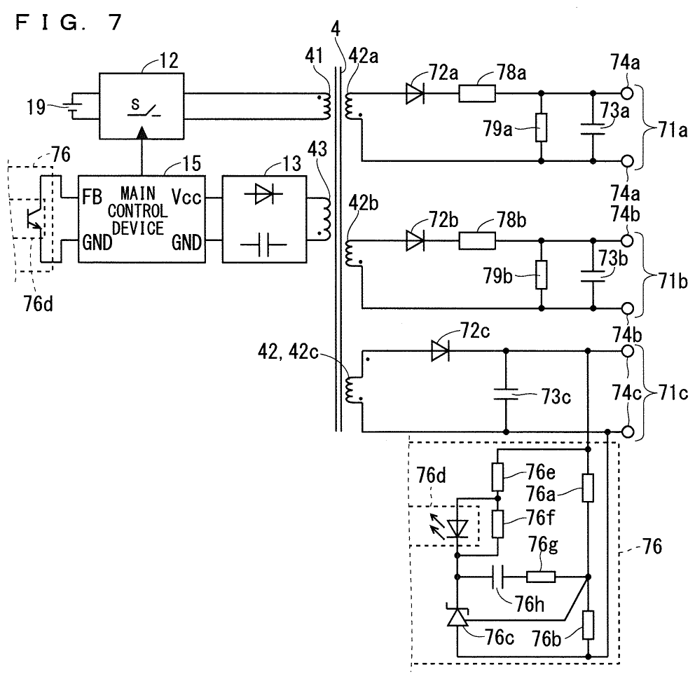

FIG. 7 is a circuit diagram illustrating a configuration of a DC-DC converter (referred to as “the third related DC-DC converter” hereinafter) relating to the DC-DC converter according to the present embodiment 2. The same reference numerals as those described in the constituent described above will be assigned to the same or similar constituent elements of the third related DC-DC converter, and the different constituent elements are mainly described hereinafter.

A configuration of the third related DC-DC converter in FIG. 7 is similar to the configuration of the DC-DC converter according to the present embodiment 2 in FIG. 5 except that the second circuits 21a and 21b and the third circuit 71 are replaced with third circuits 71a, 71b, and 71c similar to the third circuit 71.

The third circuit 71a is connected to the secondary winding 42a, and includes a diode 72a, a capacitor 73a, and a pair of output terminals 74a similar to the diode 72, the capacitor 73, and the pair of output terminals 74 in FIG. 5. The third circuit 71a includes a power control resistance 78a and a power consumption resistance 79a.

The third circuit 71b is connected to the secondary winding 42b, and includes a diode 72b, a capacitor 73b, and a pair of output terminals 74b similar to the diode 72, the capacitor 73, and the pair of output terminals 74 in FIG. 5. The third circuit 71b includes a power control resistance 78b and a power consumption resistance 79b.

The third circuit 71c is connected to the secondary winding 42c, and includes a diode 72c, a capacitor 73c, and a pair of output terminals 74c similar to the diode 72, the capacitor 73, and the pair of output terminals 74 in FIG. 5.

In the third related DC-DC converter in FIG. 7, output voltage of one of the plurality of third circuits 71a to 71c (the third circuit 71c in FIG. 7) which is the plurality of output circuits is input to the feedback circuit 76. The main control device 15 controls the conduction ratio of the switching element 12 based on a feedback signal from the feedback circuit 76 so that the output voltage becomes the target value.

In the meanwhile, output voltage of the third circuits 71a and 71b other than the third circuit 71c, that is to say, output voltage which is not directly controlled is roughly calculated using a turn ratio of the transformer to the output voltage of the third circuit 71c, that is to say, the output voltage which is directly controlled. However, the output voltage of the output circuit which is not directly controlled in the multi-output DC-DC converter fluctuates depending on a load of the controlled output circuit and on a load and input voltage in each output circuit. The output voltage of the output circuit which is not directly controlled is hardly adjusted accurately.

The output voltage which is not directly controlled is generally adjusted by various parameters such as a change in the number of turns of the transformer 4, a change in a primary side inductance value of the transformer 4, an addition of the power control resistances 78a and 78b and the power consumption resistances 79a and 79b to each winding, an order of turns of the transformer 4, and a change in a turn position of the winding, for example. However, it is difficult to adjust the output voltage by reason that there are various parameters. There is a problem that a redesign and a readjustment, for example, need to be performed by changing a transformer, adding an insulating tape, changing a varnish impregnation condition, and changing a manufacturer (material) of a transformer core, for example.

Considered is a configuration that a low dropout (LDO) regulator or a three-terminal regulator is provided in the third circuits 71a and 71b which are not directly controlled to simplify the adjustment of the output voltage of the configuration in FIG. 7 and suppress decrease in accuracy of the output voltage. However, cost increases in such a configuration. The LDO regulator and the three-terminal regulator can generally handle only output voltage of approximately 15V at a maximum, and even an output voltage variable regulator can handle only output voltage of approximately 40V at a maximum, so that the above configuration can hardly handle relatively high voltage. In addition, output current of the LDO regulator and the three-terminal regulator is generally approximately several tens of mA to 1.5 A, so that the above configuration cannot handle large current. There is a problem that cost further increases if a heatsink is attached to these elements to flow large current.

In contrast, according to the present embodiment 2, highly accurate output voltage having fine regulation characteristics can be obtained in each output circuit of the multi output DC-DC converter. A magnetic component can be gathered in one transformer 4, thus a multi-output DC-DC converter mounted at low cost and high density can be achieved. A flyback transformer often used in a multi-output DC-DC converter can be easily designed, thus a development period and a manufacturing period can be reduced.

The LDO regulator or the three-terminal regulator is not used in the DC-DC converter according to the present embodiment 2, thus a range of voltage and current which can be handled by the DC-DC converter can be relatively expanded. In addition, an inductor having a large inductance value is necessary when a new DC-DC converter is used for output to handle large current, however, according to the present embodiment 2, such a large-size component needs not be added. In the present embodiment 2, a MOSFET performs an operation similar to a behavior of a synchronous rectification, thus reduction in power consumption can be expected compared with a configuration of using a general power control resistance and a power consumption resistance, for example.

### Modification Example 1

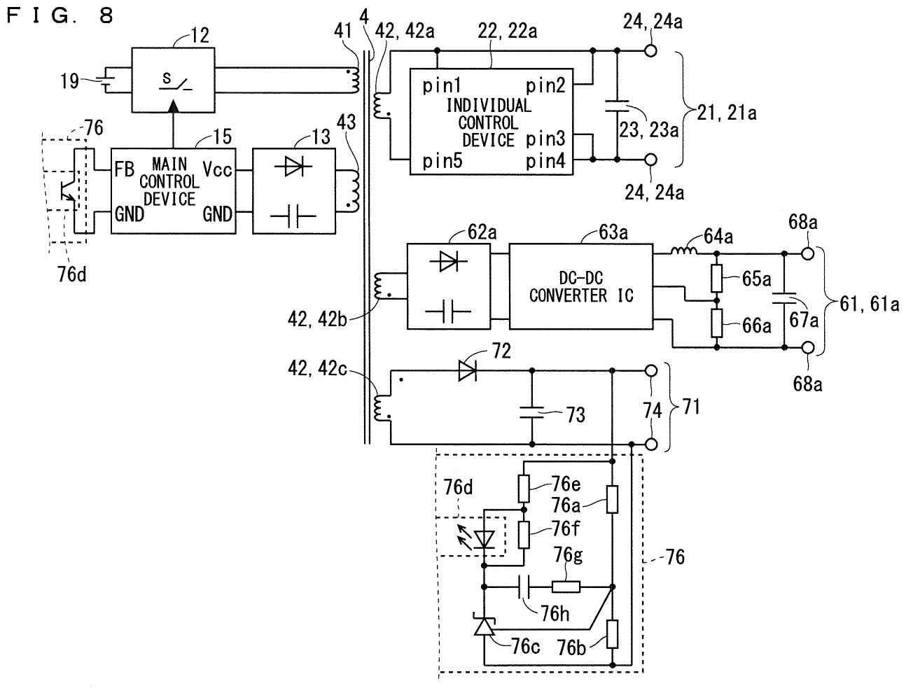

The DC-DC converter according to the embodiment 1 (FIG. 1) includes the second circuit 21 as the output circuit. However, as illustrated in FIG. 8, the DC-DC converter according to the embodiment 1 may include not only the second circuit 21 but also a fourth circuit 61 as the output circuit. Even in this case, the effect described in the embodiment 1 can be obtained in some degree.

The DC-DC converter according to the embodiment 2 (FIG. 5) includes the second circuit 21 and the third circuit 71 as the output circuit. However, although not shown in the drawings, the DC-DC converter according to the embodiment 2 may include not only the second circuit 21 and the third circuit 71 but also the fourth circuit 61 as the output circuit. Even in this case, the effect described in the embodiment 2 can be obtained in some degree.

### Modification Example 2

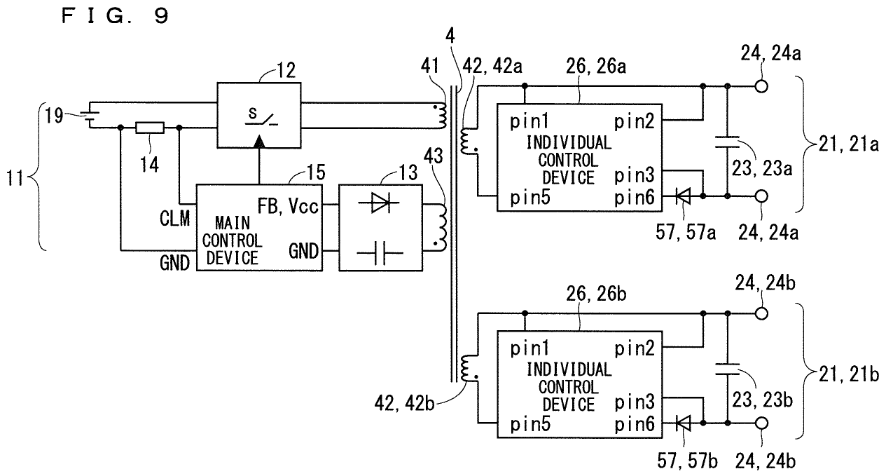

FIG. 9 is a circuit diagram illustrating a configuration of a DC-DC converter according to a modification example 2. The same reference numerals as those described in the above embodiments and modification example will be assigned to the same or similar constituent element in the configuration according to the present modification example 2, and the different constituent elements are mainly described hereinafter.

A configuration of the DC-DC converter in FIG. 9 is similar to the configuration of the DC-DC converter in FIG. 1 except that a diode 57 (57a, 57b) is added and the individual control device 22 (individual control device 22a, 22b) is replaced with the individual control device 26 (individual control device 26a, 26b). The individual control device 26 (individual control device 26a, 26b) includes a terminal pin 6 in the individual control device 22 (individual control device 22a, 22b). The diodes 57a and 57b are connected between the terminal pin 6 of the individual control device 26 (individual control device 26a, 26b) and the output terminal 24a, respectively. Although not shown in the drawings, no element is connected to the terminal pin 4 of the individual control devices 26a and 26b.

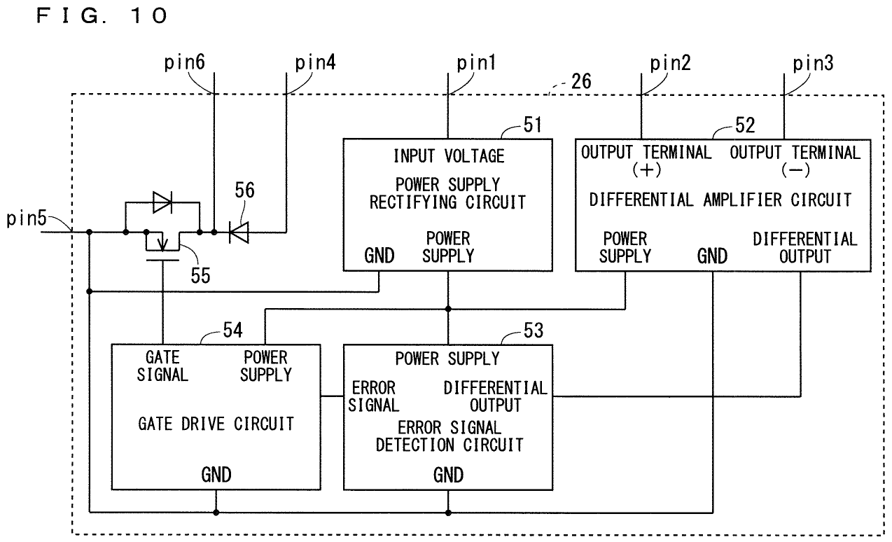

FIG. 10 is a block diagram illustrating an example of a configuration of the individual control device 26 (individual control device 26a, 26b) according to the present modification example 2. In the individual control device 26, the terminal pin 6 is connected to a connection point of the switching element 55 and the diode 56.

Herein, the diode 56 generally tends to generate larger heat than the switching element 55 due to a forward loss. In view of this, the terminal pin 6 lead from the connection point of the switching element 55 and the diode 56 is provided in FIG. 10. Accordingly, the diodes 57a and 57b such as a Schottky barrier diode (SBD) having small forward voltage can be externally used instead of the diode 56 inside the individual control device 26. As a result, the heat generation can be dispersed to the plurality of component such as the individual control device 26 and the diode 57 while suppressing the loss.

### Embodiment 3

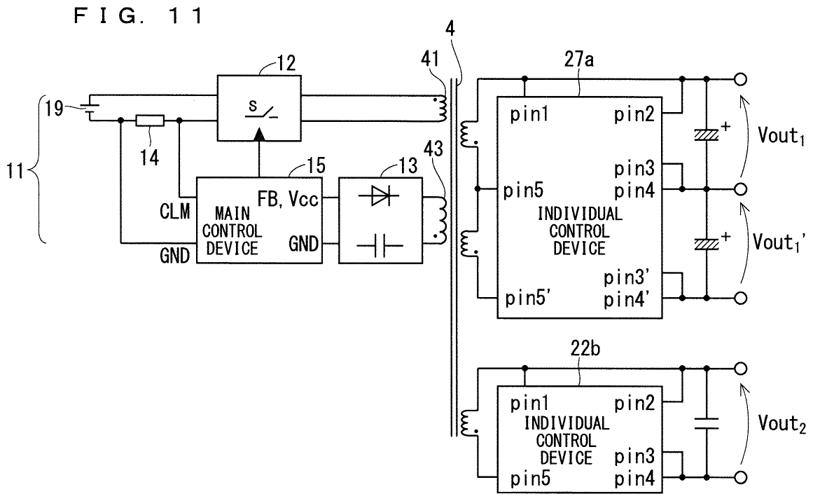

FIG. 11 is a circuit diagram illustrating a configuration of a DC-DC converter according to an embodiment 3 of the present invention. The same reference numerals as those described in the above embodiments will be assigned to the same or similar constituent element in the configuration according to the embodiment 3, and the different constituent elements are mainly described hereinafter.

A configuration of the DC-DC converter in FIG. 11 is similar to the configuration of the DC-DC converter in FIG. 1 except that the individual control device 22a is replaced with an individual control device 27a.

The individual control device 27a further includes terminals pin 3′ to pin 5′ similar to the terminals pin 3 to pin 5 of the individual control device 22a. A connection point of the terminal pin 3 and the terminal pin 4 and the terminal pin 2 are connected to an output Vout₁ via a capacitor. The connection point of the terminal pin 3 and the terminal pin 4 and a connection point of the terminal pin 3′ and the terminal pin 4′ are connected to an output Vout₁′ via a capacitor. That is to say, the individual control device 27a includes two outputs (the output Vout₁ and the output Vout₁′). The individual control device 27a according to the present embodiment 3 is configured to control the two outputs (the output Vout₁ and the output Vout₁′).

A configuration on a side of the individual control device 22b is similar to that on a side of the individual control device 22b in the embodiment 1, and the connection point of the terminal pin 3 and the terminal pin 4 and the terminal pin 2 of the individual control device 22b are connected to an output Vout₂ via a capacitor.

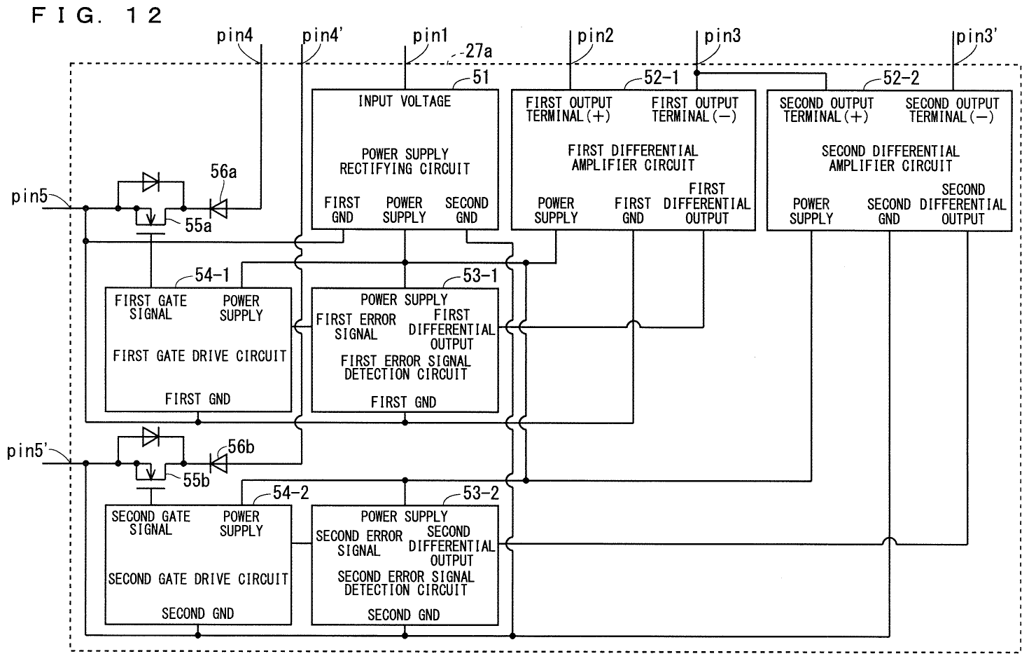

FIG. 12 is a block diagram illustrating an example of a configuration of the individual control device 27a in a case where Vout₁ #Voutr is satisfied in FIG. 11. A configuration of the individual control device 27a in FIG. 12 is similar to the configuration of the individual control device 22 in FIG. 2 except that two differential amplifier circuits 52, two error signal detection circuits 53, two gate drive circuits 54, two switching elements 55, and two diodes 56 are included. Specifically, the individual control device 27a in FIG. 12 includes the power supply rectifying circuit 51, the differential amplifier circuits 52-1 and 52-2, the error signal detection circuits 53-1 and 53-2, the gate drive circuits 54-1 and 54-2, the switching elements 55a and 55b, and the diodes 56a and 56b.

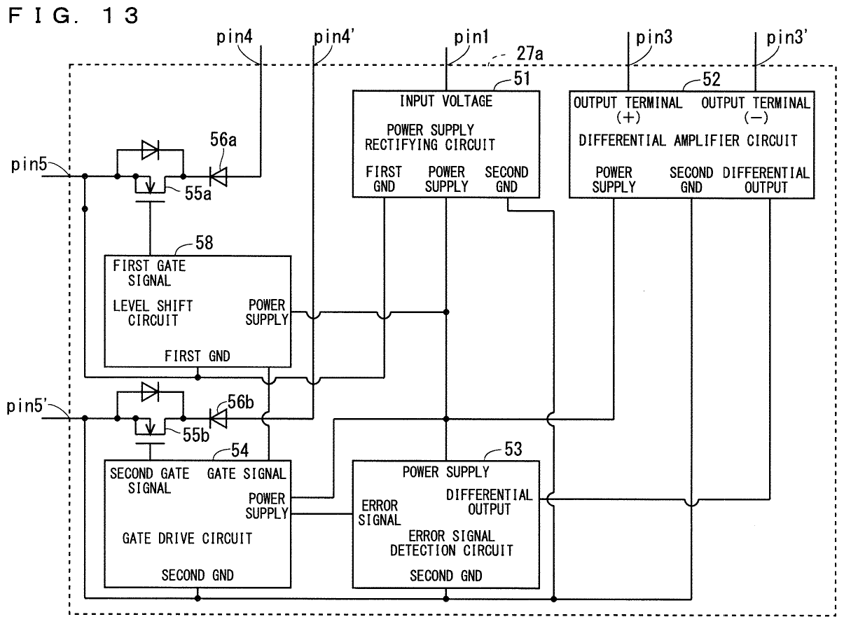

FIG. 13 is a block diagram illustrating an example of a configuration of the individual control device 27a in a case where Vout₁=Vout₁′ is satisfied in FIG. 11, that is to say, the output Vout₁ and the output Vout₁′ are substantially the same. The configuration of the individual control device 27a in FIG. 13 is similar to the configuration of the individual control device 22 in FIG. 2 in which a level shift circuit 58 is added. In the configuration in FIG. 13, the level shift circuit 58 needs to be added compared with the configuration in FIG. 12, however, each of the differential amplifier circuits, the error signal detection circuits, and the gate drive circuits can be gathered together, thus the IC can be further downsized.

According to the present invention, each embodiment and each modification example can be arbitrarily combined, or each embodiment and each modification example can be appropriately varied or omitted within the scope of the invention.

The present invention has been shown and described in detail, the foregoing description is in all aspects illustrative, thus the present invention is not limited thereto. It is therefore understood that numerous modification examples can be devised without departing from the scope of the invention.

### EXPLANATION OF REFERENCE SIGNS

4 transformer, 11 first circuit, 12, 55 switching element, 15 main control device, 21, 21a, 21b second circuit, 22, 22a, 22b, 26, 26a, 26b, 27a individual control device, 41 primary winding, 42, 42a, 42b secondary winding, 43 bias winding, 56, 57, 57a, 57b diode, 61, 61a, 61b fourth circuit, 63a, 63b DC-DC converter IC, 64a, 64b inductor, 71 third circuit, 76d photo coupler.

1. A DC-DC converter, comprising:
a transformer including a primary winding, at least one secondary winding, and a tertiary winding;
a first circuit connected to the primary winding and the tertiary winding; and
at least one second circuit connected to the at least one secondary winding, wherein
the first circuit includes:
a first switching element converting a predetermined DC voltage into an AC voltage, and supplies the AC voltage to the primary winding; and
a main control device controlling a conduction ratio of the first switching element based on an electrical power of the tertiary winding,
the second circuit includes
an individual control device selectively accumulating and taking out an electrical power in the secondary winding corresponding to the second circuit based on the electrical power taken out from the secondary winding,
the individual control device includes:
a differential amplifier circuit amplifying voltage of the secondary winding corresponding to the second circuit;
an error signal detection circuit generating an error signal based on a comparison between the voltage amplified in the differential amplifier circuit and preset voltage; and
a gate drive circuit selectively accumulating and taking out an electrical power in the secondary winding based on the error signal, and
the second circuit converts an AC voltage of the secondary winding corresponding to the second circuit into a DC voltage.

2. The DC-DC converter according to claim 1, wherein
the individual control device further includes:
a second switching element whose one end is connected to one end of the secondary winding corresponding to the individual control device; and
a diode connected to another end of the second switching element, wherein
when current flows in a forward direction of the diode, the individual control device switches the second switching element from an on state to an off state or from an off state to an on state based on an electrical power taken out from the secondary winding corresponding to the individual control device.

3. The DC-DC converter according to claim 1, further comprising
a third circuit connected to the at least one secondary winding, wherein
a photo coupler transmitting a signal corresponding to an AC voltage of the secondary winding corresponding to the third circuit to the first circuit is provided between the first circuit and the third circuit, and
the main control device of the first circuit controls a conduction ratio of the first switching element based on an electrical power of the tertiary winding and a signal from the photo coupler.

4. The DC-DC converter according to claim 1, further comprising
at least one fourth circuit connected to the at least one secondary winding, wherein
the fourth circuit includes:
an inductor provided individually from the secondary winding corresponding to the fourth circuit to accumulate an electrical power taken out from the secondary winding; and
a DC-DC converter IC selectively accumulating and taking out an electrical power in the inductor based on an electrical power taken out from the inductor, wherein
the fourth circuit converts an AC voltage of the inductor into a DC voltage.

5. The DC-DC converter according to claim 1, wherein
the individual control device each includes two outputs and controls the two outputs.

6. The DC-DC converter according to claim 2, wherein
the gate drive circuit
outputs a gate signal, which is for reducing the difference between the voltage which is amplified and the preset voltage, to the second switching element based on the error signal, and
controls a conduction ratio of the second switching element by the gate signal, thereby selectively accumulating and taking out the electrical power in the secondary winding.

7. The DC-DC converter according to claim 6, wherein
a reflux diode is connected to the second switching element.
